(19) United States
(12) Patent Application Publication
(10) Pub. No.: US 2017/0108202 A1
(43) Pub. Date: Apr. 20, 2017

(54) Illuminant Comprising an LED

(71) Applicant: TRIDONIC GMBH & CO KG, Dornbirn (AT)

(72) Inventors: Klaus Mundle, Feldkirch (AT); Johannes Tschofen, Gotzis (AT); Phillip Zudrell, Bartholomaberg (AT)

(73) Assignee: General LED, Inc., San Antonio, TX (US)

(21) Appl. No.: 15/312,472

(22) PCT Filed: May 5, 2015
(86) PCT No.: PCT/AT2015/050110

§ 371 Date: Nov. 18, 2016

(30) Foreign Application Priority Data
May 19, 2014 (AT) GM213/2014

(51) Int. Cl. F21V 23/00; F21V 3/00; F21V 9/08; F21V 7/00; F21V 19/00; F21V 31/00; F21S 4/28

(52) U.S. Cl. CPC F21V 23/001; F21V 31/005; F21V 3/00; F21S 4/28; F21V 7/00; F21V 19/003; F21V 9/08; F21Y 2115/10

(57) ABSTRACT

A method for assembling and contacting an illuminant comprising one light emitting diode, having a support element on which the light emitting diode is arranged having passage openings in the electrical contact region of a cable and preferably in the vicinity of a cable. The method comprises contacting the cable with the support element and applying a hot melt adhesive to the cable and the support element; and thereby mechanically connecting the cable to the support element. The hot melt adhesive is applied to the support element in such a way that the hot melt adhesive fills the passage openings and lies on both sides of the support element.

The invention relates to an illuminant comprising light emitting diodes according to the preamble of patent claim 1, and to a method for mounting and contacting an illuminant comprising light emitting diodes according to the preamble of patent claim 10.

### TECHNICAL FIELD

Such illuminants are used in lighting systems or for effect lighting in order to achieve lighting of rooms or paths or else of advertising texts or for advertising purposes. In this case, the illuminants are usually driven and activated as necessary by operating devices. Inorganic and organic light emitting diodes (LEDs) are used as light source for such lighting.

### PRIOR ART

For lighting purposes, instead of gas discharge lamps and incandescent lamps, light emitting diodes are also being used more and more often as light source. The efficiency and luminous efficiency of light emitting diodes is being increased to a greater and greater extent, such that they are already in use in various applications of general lighting. They afford the advantage that light emitting diodes of different colors may be mixed and color-variable lighting arrangements may thus be realized. However, light emitting diodes are point light sources and emit highly concentrated light.

In general lighting, for example of offices or else in the case of path lighting arrangements or the lighting of stairwells, lighting that is as areal and uniform as possible is demanded by the user, however.

In order to realize large-area lighting or else lighting with many points of light, a system is therefore required as to how the individual illuminants can be positioned in a simple manner.

### SUMMARY OF THE INVENTION

The object of the invention is to provide an illuminant and a method which enables the mounting and the contacting of an illuminant comprising light emitting diodes without the abovementioned disadvantages or with a significant reduction of said disadvantages.

This object is achieved for a device of the generic type according to the invention by means of the characterizing features of patent claim 1 and for a method according to the invention by means of the characterizing features of patent claims 10. Particularly advantageous embodiments of the invention are described in the dependent claims.

The solution according to the invention for an illuminant comprising light emitting diodes is based on the concept that the light emitting diodes are arranged on a carrier element and The carrier element is electrically connected to at least one cable, wherein the carrier element comprises passage openings in the region of the electrical contacting of the cable, and wherein the cable is mechanically connected to the carrier element by means of a hot melt adhesive, and the hot melt adhesive encloses the cable, wherein the hot melt adhesive is arranged on both sides of the carrier element and fills the passage openings.

In this way, it is possible to achieve a simple and mechanically stable contacting with a cable for an illuminant comprising light emitting diodes.

### DESCRIPTION OF THE PREFERRED EXEMPLARY EMBODIMENTS

The invention will be explained in greater detail below with reference to the accompanying drawing, in which:

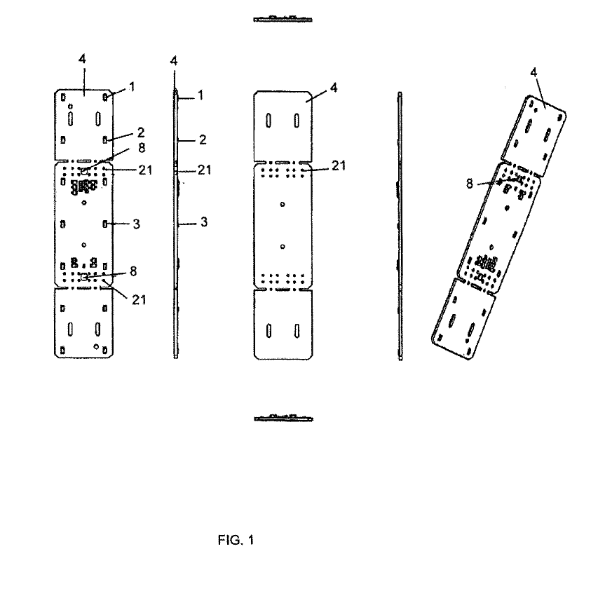

FIG. 1 shows a configuration of an illuminant according to the invention

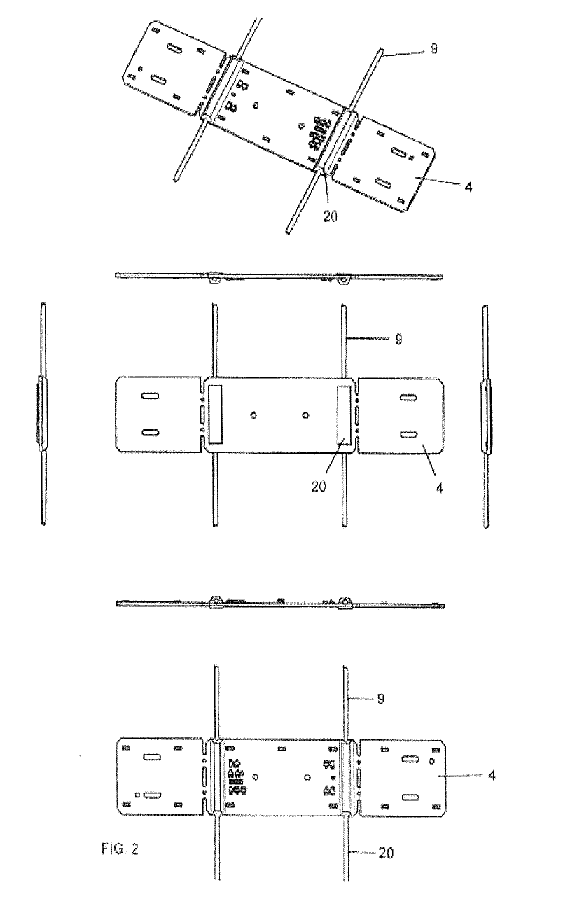

FIG. 2 shows a configuration of an illuminant according to the invention with a view of the assembled elements

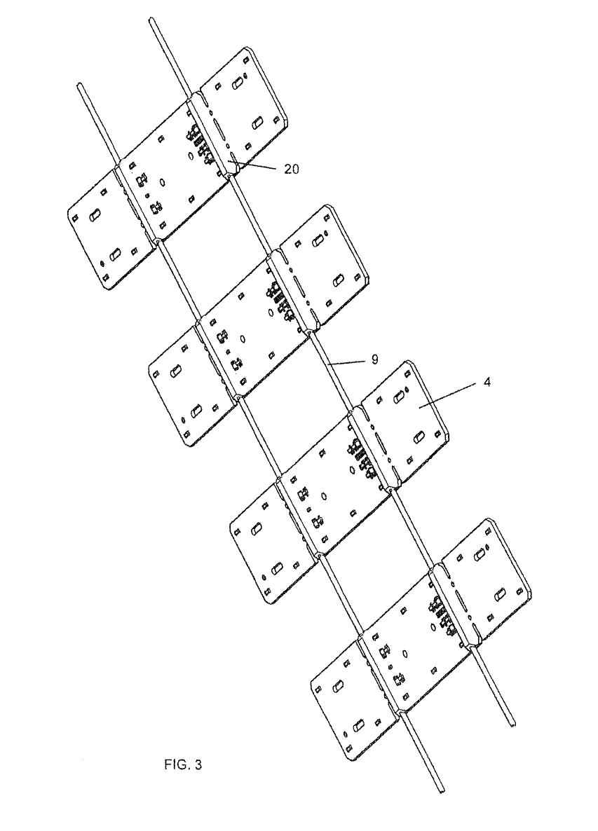

FIG. 3 shows further views of an illuminant according to the invention

The invention is explained below on the basis of an exemplary embodiment of an illuminant comprising light emitting diodes. The illuminants preferably form so-called LED modules or light emitting diode modules.

As illustrated in FIGS. 1 and 2, the light emitting diodes 1, 2 and 3 are the light sources of the illuminant A. Instead of a respective individual light emitting diode 1, however a group of light emitting diodes 1′, 1″, 1″′ may also be combined in each case.

The light emitting diodes 1, 2 and 3 are arranged on a carrier element 4. In this exemplary embodiment, the carrier element 4 is configured as a printed circuit board. The carrier element 4 furthermore has a polygonal basic area. The carrier element 4 may optionally be inserted in a housing (not illustrated). The carrier element 4 comprises one or a plurality of passage openings 21. Preferably, a plurality of passage openings 21 are present at a close distance from one another. The passage openings 21 may be configured as openings in the carrier element 4 in a manner similar to plated-through holes in printed circuit boards.

Furthermore, the carrier element 4 comprises contact locations 8. The contact locations 8 are electrically directly or indirectly connected to the light emitting diodes 1, 2 and 3. An indirect electrical connection is present if drive electronics (for example a driver circuit) are present, by means of which the current through and/or the voltage across the light emitting diodes 1, 2, 3 are/is set.

The cable 9 is preferably formed by an insulated conductor core, for example a wire.

FIG. 2 illustrates an illuminant comprising at least one light emitting diode 1, 2 and 3 in several perspectives. The light emitting diodes 1, 2, 3 are arranged on a carrier element 4, preferably on the top side. At least one cable 9 is electrically connected to the carrier element 4. The carrier element 4 comprises passage openings 21 in the region of the electrical contacting of the cable 9 and preferably in the vicinity of the cable 9. The cable 9 is mechanically connected to the carrier element 4 by means of a hot melt adhesive 20.

The hot melt adhesive 20 encloses the cable 9, wherein the hot melt adhesive 20 is arranged on both sides of the carrier element 4 and fills the passage openings 21. In the cured state, the hot melt adhesive 20 forms a strain relief element for the cable 9 and thus performs the function of strain relief. The strain relief element in the form of the hot melt adhesive 20 ensures the mechanical connection between cable 9 and carrier element 4.

The contact locations 8 may be configured as soldering location. The contact locations 8 are preferably arranged in the vicinity of the passage openings 21. The electrical contacting of the cable 9 with the carrier element 4 is preferably reflected as soldering connection. For this purpose, the insulation may be stripped from the cable 9 at the corresponding contacting points and the cable may be soldered by means of soldering connection in each case to a contact location 8, in order to achieve an electrical contacting between carrier element 4 and cable 9. Alternatively, an electrical contacting of the cable 9 with the carrier element 4 may be effected by means of a crimp contact (clamping) or a piercing contact, for example.

In this case, the electrical contacting of the cable 9 with the carrier element 4 is preferably effected in each case by means of an electrical contacting of the contacting points of the cable 9 with a contact location 8, wherein the contact locations 8 are electrically directly or indirectly connected to the light emitting diodes 1, 2 and 3.

The top side of the carrier element 4 may be configured as a reflector or have a reflective surface.

A fixing means, preferably an adhesive tape, may be arranged on the underside of the carrier element 4.

A lens may cover the carrier element 4 with the light emitting diodes 1, 2, 3. The lens may be connected to the housing or the carrier element 4 in such a way that the light emitting diodes 1, 2, 3 are protected against ingress of moisture. The lens may be placed as an optical element onto the carrier element 4. The lens may also be configured as at least one globe top.

The light emitting diodes 1, 2 and 3 are applied on the carrier element 4 using surface mount technology (SMT) or chip-on-board technology (COB).

In the case where the light emitting diodes 1, 2 and 3 are applied using surface mount technology (SMT), they may be configured as SMD light emitting diodes.

By employing chip-on-board (COB) technology for applying the LEDs, it is possible to achieve a very good thermal coupling of the LEDs to the carrier element 4; in addition, chip-on-board (COB) technology enables a very close placement of light emitting diodes, as a result of which a very homogeneous light distribution may be achieved in the case of a positioning of groups of light emitting diodes.

The light emitting diodes 1, 2 and 3 may consist of an LED semiconductor chip, which may be covered by a potting compound.

This lens-shaped potting compound, which is advantageously highly transparent, firstly protects the LED semiconductor chips and may additionally act as a lens in order to orient and optimally couple out the light radiation emitted by the LED semiconductor chips. This lens composed of potting compound is generally referred to as a primary optical unit of the light emitting diode. The lens may be configured as at least one globe top. The potting compound has a lens effect and may also contain a color conversion substance. By way of example, the light of a blue LED semiconductor chip may be converted into white light by the color conversion substance.

A fixing element 13 may be fitted on the underside of the carrier element 4, which fixing element may be used either with a profile rail or for fitting on a housing of a light box.

Preferably when a housing is present, the contacting of the cable 9 may be protected against ingress of moisture. A sealing of the housing for example by means of sealing lips makes it possible to prevent moisture from penetrating into the illuminant, and thus to produce an illuminant of the protection class IP65. Penetration of moisture might lead for example to a short circuit in the illuminant or else to the accelerated ageing of the light emitting diodes.

The carrier element 4 advantageously has a high thermal conductivity in order to effectively dissipate the heat generated by the light emitting diodes 1 and 2 and to keep the temperature of the LED semiconductor chips as low as possible. The carrier element 4 may at least also partly be configured as a reflector in order to achieve a better coupling out of light by the light emitting diodes 1 and 2.

The carrier element 4 preferably consists of an electrically insulating material. The carrier element 4 may consist of a plastics material, a glass fiber substrate impregnated with epoxy resin, a ceramic substrate, glass or else a silicon substrate. In one exemplary embodiment, the carrier element 4 may consist of a ceramic substrate. The ceramic substrate may preferably be realized as an LTCC structure (Low Temperature Cofired Ceramic). By employing an LTCC structure, an at least partial integration of components such as resistors or capacitances or else conductor tracks is possible. The at least partial integration enables a part of the drive electronics 19 for the light emitting diodes 1 and 2 to be integrated into the carrier element 4.

A part of the drive electronics 19 may be for example the driver circuit or a part thereof, an interface circuit or else a sensor, such as, for example, a temperature, brightness or color sensor, for monitoring the light emitting diodes 1 and 2. By way of example, a temperature monitoring circuit may also be present, wherein the temperature at the light emitting diodes 1, 2 and 3 or on the carrier element 4 is detected by means of a temperature sensor, and the current or the power at the light emitting diodes 1, 2 and 3 may be reduced in the case of a limit value for a temperature being exceeded.

By way of example, the supply lines for the light emitting diodes 1 and 2 are integrated into the carrier element 4. However, the electrical supply lines for the light emitting diodes 1 and 2 may preferably be applied on the carrier element 4.

Drive electronics 19 for driving and/or monitoring the light emitting diodes 1, 2, 3 may be fitted on, in and/or below the carrier element 4. By way of example, there may be drive electronics 19 on the top side and/or on the underside of the carrier element 4.

By way of example, in the case where a multilayer printed circuit board is employed as carrier element 4, at least one part of the drive electronics 19 may be embedded into the multilayer printed circuit board. The carrier element 4 may also be a printed circuit board which is reinforced with a metallic plate. In this case, the metallic plate may contribute to better heat dissipation and also to increasing the stability. The drive electronics 19 may comprise for example a driver circuit for the light emitting diodes 1, 2, 3, but also a monitoring circuit for the light emitting diodes 1, 2, 3.

By way of example, electrical, thermal and/or optical parameters of the light emitting diodes 1, 2, 3 or of the entire illuminant may be detected and monitored.

At least one of the light emitting diodes 1, 2, 3 may be an organic or an inorganic light emitting diode.

Advertising lighting or else effect lighting may be realized with the aid of one or more illuminants according to the invention. Preferably, the light emitting diodes 1, 2, 3 may be driven individually or in groups. It is thus possible to construct, for example, advertising lighting comprising a light box comprising at least one illuminant according to the invention.

However, a profile rail may also be equipped with the aid of one or more illuminants according to the invention. In this case, it is possible to use the profile rail comprising at least one illuminant for forming a linear light source, in particular for illuminating refrigeration appliances or letters.

A method for releasably contacting an illuminant comprising at least one light emitting diode 1, 2, 3 is thus made possible, comprising a carrier element 4, on which the light emitting diodes 1, 2, 3 are arranged, wherein the carrier element 4 comprises passage openings 21 in the region of the electrical contacting of the cable 9 and preferably in the vicinity of the cable 9, comprising the following steps: contacting the cable 9 with the carrier element 4, applying a hot melt adhesive 20 to the cable 9 and the carrier element 4, wherein the hot melt adhesive 20 encloses the cable 9 and thus mechanically connects the cable 9 to the carrier element 4, wherein the hot melt adhesive 20 is applied to the carrier element 4 in such a way that the hot melt adhesive 20 fills the passage openings 21 and is arranged on both sides of the carrier element 4.

The hot melt adhesive 20 may be applied to the carrier element 4 by means of injection molding methods and preferably at a temperature below 230 degrees Celsius, and in particular at a temperature above 180 degrees Celsius.

The hot melt adhesive 20 may be applied to the top side of the carrier element 4 in such a way that the hot melt adhesive 20 penetrates through the passage openings 21 and emerges from the passage openings 21 on the underside of the carrier element 4.

The method step of applying the hot melt adhesive 20 may be carried out in such a way that a mold is placed on both sides of the carrier element 4.

The hot melt adhesive 20 is applied to the carrier element 4 by injection into the mold preferably at a pressure of approximately 40 bar.

A method for contacting an illuminant is thereby made possible which may be realized in a very simple and cost-effective manner and at the same time ensures a high mechanical stability for the illuminant and in particular the contacting of the cable.

As a result, an arrangement of a plurality of illuminants on a cable 9 is possible in which the spacing apart of a plurality of illuminants with respect to one another on the cable 9 is selectable by corresponding spacing apart of the individual illuminants with respect to one another (i.e. the respective distance between 2 illuminants).

FIG. 3 illustrates various views of a plurality of illuminants according to the invention that are connected to cables 9.

The cable 9 may be connected to the carrier element 4 and contacted therewith for example also by one of its two ends. In this case, an individual connection from a cable to a carrier element 4 of an illuminant may be produced by means of the stream relief element in the form of the hot melt adhesive 20.

The illuminant may be fitted on a profile rail. The carrier element 4 may be fitted on a profile rail and be displaced within the profile rail. In this case, the carrier element 4 may be fitted releasably on a profile rail. It may be clamped into the profile rail, for example.

The profile rail comprising at least one illuminant may be used for forming a linear light source, in particular for illuminating of refrigeration appliances or letters.

1. An illuminant comprising
at least one light emitting diode (1, 2, 3),
a carrier element (4), on which the light emitting diode (1, 2, 3) is arranged preferably on the top side,
at least one cable (9) which is electrically connected to the carrier element (4), characterized in that the carrier element (4) comprises passage openings (21) in the region of the electrical contacting of the cable (9) and preferably in the vicinity of the cable (9), wherein the cable (9) is mechanically connected to the carrier element (4) by means of a hot melt adhesive (20), and the hot melt adhesive (20) encloses the cable (9), wherein the hot melt adhesive (20) is arranged on both sides of the carrier element (4) and fills the passage openings (21).

2. The illuminant as claimed in claim 1, characterized in that the electrical contacting of the cable (9) with the carrier element (4) is configured as a soldering connection.

3. The illuminant as claimed in claim 1 or 2, characterized in that a fixing means (13), preferably an adhesive tape, is arranged on the underside of the carrier element (4).

4. The illuminant as claimed in claim 3, characterized in that the illuminant is configured to be fitted releasably on a profile rail or a housing of a light box.

5. The illuminant as claimed in any of claims 1 to 4, characterized in that a lens covers the carrier element (4) with the light emitting diodes (1, 2, 3).

6. The illuminant as claimed in claim 5, characterized in that the lens is connected to a housing or the carrier element (4) in such a way that the light emitting diodes (1, 2, 3) are protected against ingress of moisture.

7. The illuminant as claimed in any of claims 1 to 6, characterized in that drive electronics (19) for driving and monitoring the light emitting diodes (1, 2, 3) are fitted on the top side and/or on the underside of the carrier element (4).

8. Advertising lighting, preferably a light box, comprising at least one illuminant as claimed in any of claims 1 to 7.

9. A profile rail comprising at least one illuminant as claimed in any of claims 1 to 7 for forming a linear light source, in particular for illuminating refrigeration appliances or letters.

10. A method for mounting and contacting an illuminant comprising at least one light emitting diode (1, 2, 3), comprising
a carrier element (4), on which the light emitting diodes (1, 2, 3) are arranged,
wherein the carrier element (4) comprises passage openings (21) in the region of the electrical contacting of the cable (9) and preferably in the vicinity of the cable (9), comprising the following steps:
contacting the cable (9) with the carrier element (4), applying a hot melt adhesive (20) to the cable (9) and the carrier element (4), wherein the hot melt adhesive (20) encloses the cable (9) and thus mechanically connects the cable (9) to the carrier element (4), wherein the hot melt adhesive (20) is applied to the carrier element (4) in such a way that the hot melt adhesive (20) fills the passage openings (21) and is arranged on both sides of the carrier element (4).

11. The method as claimed in claim 10, characterized in that the hot melt adhesive (20) is applied to the carrier element (4) by means of injection molding methods and preferably at a temperature below 230 degrees Celsius, and in particular at a temperature above 180 degrees Celsius.

12. The method as claimed in claim 10 or 11, characterized in that the hot melt adhesive (20) to the top side of the carrier element (4) in such a way that the hot melt adhesive (20) penetrates through the passage openings (21) and emerges from the passage openings (21) on the underside of the carrier element (4).

13. The method as claimed in claim 11 or 12, characterized in that the method step of applying the hot melt adhesive (20) is carried out in such a way that a mold is placed on both sides of the carrier element (4) and the hot melt adhesive (20) is applied to the carrier element (4) by injection into the mold at a pressure of approximately 40 bar.
